(19) United States
(12) Patent Application Publication
(10) Pub. No.: US 2021/0076762 A1
(43) Pub. Date: Mar. 18, 2021

(54) FIRE-RETARDING COMPOSITION, PROCESS FOR PRODUCTION OF THE COMPOSITION, FIRE- RETARDING MIXTURE COMPRISING THE COMPOSITION AND TREATMENT OF FABRICS WITH THE COMPOSITION

(71) Applicant: PROSETEX S.P.A., BULCIAGO (IT)

(72) Inventors: DAVIDE COLOMBO, BULCIAGO (IT); ALESSANDRA ACCOGLI, DISO (IT); LUCA MAGAGNIN, RHO (IT); EUGENIO GIBERTINI, CUSAGO (IT)

(21) Appl. No.: 16/971,841

(22) PCT Filed: Feb. 26, 2019
(86) PCT No.: PCT/IB2019/051523

§ 371 Date: Aug. 21, 2020

(30) Foreign Application Priority Data
Feb. 26, 2018 (IT) 102018000003031

(51) Int. Cl. A41D 31/08; D06M 11/71; D06M 11/74; D06M 23/04; C09K 21/04; C08K 3/32

(52) U.S. Cl. CPC A41D 31/08; D06M 11/71; D06M 11/74; C08K 2003/322; C09K 21/04; C08K 3/32; D06M 2200/30; D06M 23/04

(57) ABSTRACT

A flame-retarding composition in the form of a homogeneous powder comprises a carbonaceous component at least partly functionalized with phosphate groups; and an ammonium phosphate compound. The invention also relates to a method for the production of such a composition, to a fire-retarding mixture in the form of a polymer dispersion comprising the powder composition and a water-based polymer emulsion, and to a method for treating a fabric comprising a step of applying a fire-retarding mixture comprising the composition onto a surface of the fabric and a step for heat treatment of the fabric.

The present invention relates to a fire-retarding powder composition, a process for the production thereof, a fire-retarding mixture comprising the powder composition, a fabric with a fire-retarding layer and a method for the fireproofing treatment of a fabric.

It is known in the technical sector of fabrics, in particular where the fabrics are used as a lining or covering, that the same are required by regulations to be fireproof in order to ensure the safety of end users.

It is also known that all textile products by nature are inflammable and respond to the application of a flame in a completely different manner depending on the chemical nature of the fibres (cotton, nylon, propylene, viscose), their orientation inside the product, the physical dimensions and the end application.

Depending on the characteristics of the product, the behaviour in response to fire is completely different: for example, the lower the ratio between mass and surface area of the material, the easier and the faster it will burn.

The combustion of the fabric is also influenced by its structure which determines the accessibility of oxygen/air, the combustive agent of the combustion reaction.

The end application of the fabric influences significantly the flame-behaviour: in the case of fabrics used for furnishing, such as curtains and hung materials, the reaction is extremely critical, due to the heat flow which spreads upwards, the double exposure to the combustive agent (air/oxygen) and transportation of the flames which is facilitated.

In the sector of the textile industry, the fireproofing treatment of fabrics is based mainly on a process involving the back-coating of products with polymer resins which are subject to different phases during the combustion process.

In the case of polymer materials, the combustion may be defined as being a catalytic exothermic reaction which is self-fuelling following the generation of free radicals, principally the species H′ and OH′, and radiant heat. The flame is an exothermic combustion in the gaseous phase and the heat generated increases the thermal degradation of the polymer material in the solid phase, causing the further emission of combustible vapours: the cycle is therefore self-fuelling and self-accelerating until the fabric has been completely burned.

Owing to their organic nature, it is not possible to develop polymers which do not burn: only the use of specific additives, known as flame-retarding agents, allows the combustibility and the speed of propagation of the flame to be reduced, resulting in some cases in a behaviour which is referred to as being “self-extinguishing”.

Flame-retardants are therefore chemical species which are designed to improve the fire-reaction of the polymer materials. Their main function is to reduce the speed of heat transfer to the polymer so as to prevent the thermal degradation process thereof, with the consequent formation of radical species which, being free, interrupt the self-fuelling cycle.

The method currently preferred in order to provide the polymer with a flame-resistant behaviour consists in adding to the polymer resin flame-retarding additives of a varying nature.

From this point of view, the fire-resistance in the case of polymers may, in general, be improved principally by adopting three different strategies:
acting in the vapour phase where the flame retardants interact with the combustion reaction in the vapour phase,
acting in the condensed phase where the flame retardants prevent the degradation of the polymer and the diffusion of heat with the formation of combustion products;
adding flame retardants which facilitate the dispersion of the heat from the polymer, limiting the thermal degradation thereof and all the processes associated with it.

Currently the desired characteristics in terms of flame resistance are achieved by means of processes involving coating the back of the fabric with polymer resins to which antimony trioxide (Sb₂O₃) is added, along with halogenated additives.

The toxicity and the environmental impact associated with antimony trioxide (Sb₂O₃) are, however, such that the use of this chemical substance must be restricted.

Further examples of the prior art are described in:

US 2005/287894 A1, which describes a coating for a fabric comprising a polymeric binder such as a latex emulsion based on an acrylic co-polymer and a flame-retarding composition intermixed with the polymer binder, as well as a dispersing and/or thickening agent suitable for achieving the desired characteristics of the coating. The flame-retarding composition includes preferably an acid donor such as ammonium polyphosphate, mono-ammonium phosphate, diammonium phosphate, potassium tripolyphosphate, or combinations thereof; (ii) a carbonaceous component such as dipentaerythritol (DPE), pentaerythritol, polyol, chlorinated paraffin, or a combinations of these; and (iii) a foaming agent such as melamine, urea, dicyandiamide or combinations thereof.

Fillers and pigments such as titanium dioxide, zinc oxide, silicates, carbon black, calcium carbonate and the like, may also be added.

U.S. Pat. No. 9,097,011 B1, which describes a heat and flame resistant system comprising a foamed substrate and at least one intumescent layer applied to a surface of the foamed substrate. The intumescent layer comprises an intumescent catalyst, a carbonific, a foaming agent, expandable graphite and a binder. According to a further aspect, the intumescent layer comprises ammonium polyphosphate, polyhydric alcohol, melamine, expandable graphite and a latex-based binder.

EP 1 842 957 A1, which describes a fibre sheet containing polyammonium phosphate with an average degree of polymerization in the range of between 10 and 40, and an expandable graphite.

JP 2005 290363 A, which describes a composition for delaying combustion, comprising polyphosphoric acid and expandable graphite.

US2016-186061 describes a process for the production of graphene oxide on the surface of which phosphoric acid, polyphosphoric acid or a mixture thereof is functionalized, in order to produce a carbonaceous material with intrinsic flame-resistance properties. The process involves a step for preparation of graphene oxide in a chamber, to which phosphoric or polyphosphoric acid and sodium hydroxide, potassium hydroxide or ammonium hydroxide are added in order to keep the pH between 3 and 5, at a temperature of between 80 and 100° C. for 10-15 hours. This process requires the use of strong acids such as phosphoric and polyphosphoric acid.

U.S. Pat. No. 4,467,495 describes a flame-retarding powder resin obtained by mixing together some reagents, which include ammonium phosphate and aldehyde or formaldehyde.

CN 106 848 280 describes the production of a material for batteries which is a composite of graphene and iron phosphate, obtained by mixing and heating graphene oxide and an ammonium phosphate compound in the presence of ferrous ions, which favour precipitation of the FePO₄ compound. A technical problem which the invention intends to solve is that of providing fire-retarding products which are an alternative to those of the prior art and are particularly suitable for surface treatments such as those for a fabric and which are preferably characterized by optimum flame-resistance properties, a low toxicity and easy disposability.

For the purposes of the present patent the term “fire-retarding” will be used to characterize a dry powder with intrinsic flame-resistance properties. The aforementioned fire-retarding powder is effective as a flame-resistant agent, in particular if added to a polymeric aqueous dispersion, and allows a polymeric mixture to be obtained suitable for the fireproofing treatment of the fabrics which makes them fire-resistant or limits the development of combustion thereof.

In connection with this problem it is also required that these products should be easy and inexpensive to produce and be able to be applied to the fabrics using normal standardized processes.

Further details may be obtained from the following description of non-limiting examples of embodiment of the subject of the present invention, provided with reference to the accompanying drawings, in which:

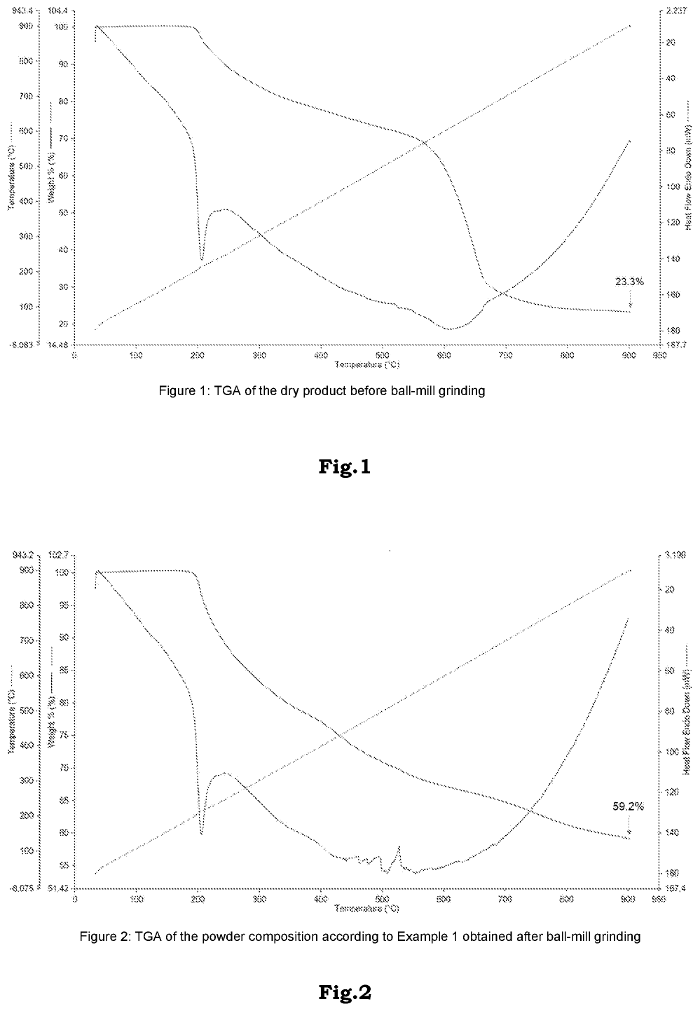

FIG. 1 is a graph illustrating the TGA analysis of the dried product obtained by means of drying before ball-mill grinding, carried out in air at a temperature ranging from 25° C. to 900° C. with a ramp of 10° C./min;

FIG. 2 is a graph illustrating the TGA analysis of the powder composition according to Example 1, after ball-mill grinding, carried out in air at a temperature ranging from 25° C. to 900° C. with a ramp of 10° C./min;

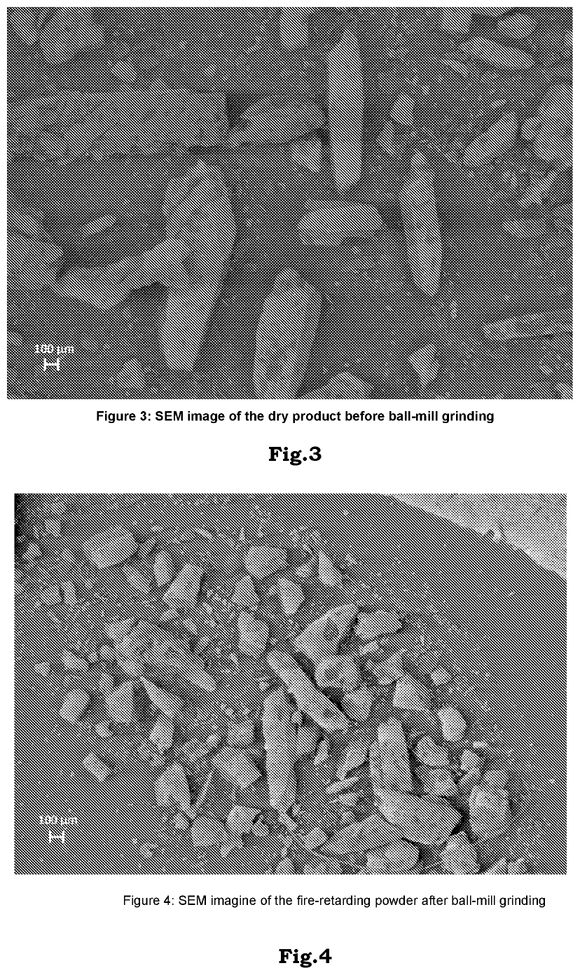

FIG. 3 shows an SEM image of the dried product before ball-mill grinding, with 100× enlargement;

FIG. 4: shows an SEM image of the powder composition after ball mill grinding according to Example 1, with 126× enlargement; and

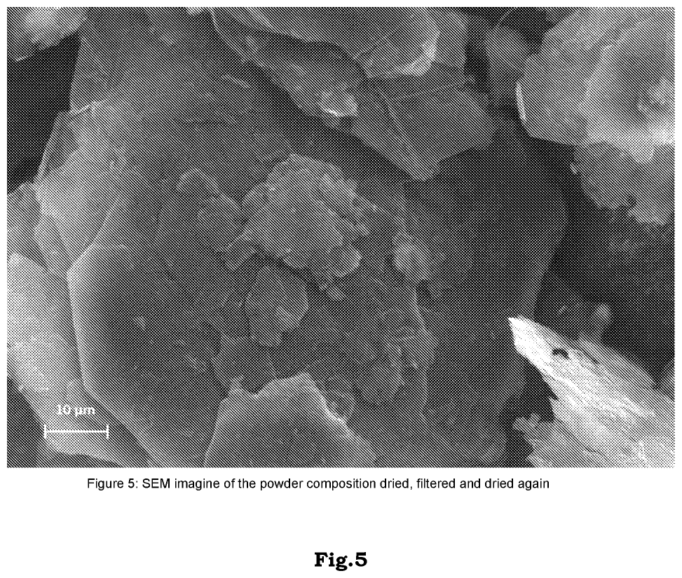

FIG. 5 shows SEM images of the dry product obtained by rinsing, filtering and drying again a powder composition according to Example 1, with 3.5 K× enlargement.

According to the invention a fire-retarding composition is provided, said composition comprising:
a carbonaceous component at least partly functionalized with phosphate groups;
an ammonium phosphate compound.

The composition according to the invention is in the form of a homogeneous powder. “Homogeneous composition” is understood as meaning that the powder composition obtained has a relative standard deviation of the quantitative compositions of respectively: carbon, nitrogen, oxygen and phosphorus, less than 10% and preferably less than or equal to 6.5%.

“At least partly functionalized with phosphate groups” is understood as meaning that part of the carbonaceous component has insoluble chemical bonds between the carbon and phosphate groups. It is believed that this functionalization, whereby phosphate groups are bonded directly to the carbon skeleton of the carbonaceous material forming in particular C—P and/or C—O—P bonds, improves the fire-retarding properties of the carbonaceous material.

Preferably, the ammonium phosphate compound is an ammonium acid salt, namely an ammonium salt of phosphoric acid, preferably chosen from ammonium phosphate monobasic NH₄H₂PO₄, ammonium hydrogen phosphate (NH₄)₂HPO₄, ammonium phosphate (NH₄)₃PO₄ and ammonium polyphosphate [NH₄PO₃]ₙ.

According to a preferred embodiment the ammonium phosphate compound is present in the final fire-retarding powder in an amount ranging between 5% and 99.5% and more preferably between 30% and 60%.

The phosphorus-based compounds act both in the condensed phase and in the vapour phase when the powder composition according to the invention is used as a flame-resistant additive, for example dispersed in aqueous or polymer solutions.

The presence of nitrogen in NH₄ increases the fire-retarding characteristics of the phosphorus compounds and allows the release of gaseous nitrogen which dilutes the inflammable gases with a consequent reduction in the size of the flame.

The carbonaceous component is chosen from one or more of the following carbonaceous materials: carbon nanotubes, graphene, graphene oxide, graphite, oxidized graphite, expandable graphite, carbon black, active carbon, alkaline or sulfonated lignin.

According to a preferred embodiment, the fire-retarding powder comprises one or more carbonaceous materials in an overall amount equal to at least 0.5% by weight, more preferably between 5% and 90% by weight, and even more preferably between 20% and 60% by weight.

According to an embodiment, the carbonaceous component comprises carbon nanotubes, preferably in an amount equal to at least 0.5% by weight, more preferably between 10% and 40% by weight of the final fire-retarding powder.

According to a preferred embodiment, the carbonaceous component comprises oxidized graphite, preferably in an amount equal to at least 0.5% by weight, more preferably between 20% and 50% by weight of the final fire-retarding powder.

According to a further preferred embodiment, the carbonaceous component comprises graphene oxide in an amount equal to at least 0.5% by weight of the powder, preferably between 5% and 80% and even more preferably between 10% and 40%.

The powder composition according to the invention has preferably a particle size of between 100 nm and 1000 μm, preferably between 200 nm and 500 μm, even more preferably between 200 nm and 50 μm, namely 90% of the particles of the composition has a greater dimension falling within the specified range.

In a preferred embodiment, the powder composition has a final residue at 900° C., measured with TGA analysis, greater than or equal to 40%, preferably between 50% and 70%, more preferably greater than or equal to 59%, which results in a high thermal resistance and therefore improved flame-resistance properties.

In order to facilitate the dispersion in a polymer emulsion, the powder composition according to the invention may preferably comprise a percentage of product soluble in water equal to at least 4% by weight. The powder composition according to the present invention may be obtained by means of a production process which comprises the following steps:
obtaining a solid product comprising the ammonium phosphate compound and at least one carbonaceous material;
mechanical cleaving of the solid product with solid/solid interaction of the components of the solid product, in particular such as to pulverize them, until a homogeneous fire-retarding power comprising a carbonaceous component at least partly functionalized with phosphate groups and an ammonium phosphate compound is obtained.

Preferably, mechanical cleaving involves mechanical grinding of the solid product until a homogeneous fire-retarding powder is obtained.

Preferably, the solid product is obtained by means of the following steps:
preparation of a colloidal dispersion of the at least one carbonaceous material in an aqueous solution of an ammonium phosphate compound;
stirring the dispersion, preferably for at least 2 hours and/or under constant volume conditions;
drying the dispersion so as to obtain a dried solid product.

The particle size of the initial carbonaceous material dispersed in the solution is generally less than one micron, but following the drying process large aggregates with dimensions also larger than 500 micrometres may form. The result of the mechanical cleaving process will be among other things to obtain a composition with a suitable particle size and homogeneity. Preferably, the colloidal dispersion is obtained from an aqueous solution, dispersing the carbonaceous material and the ammonium phosphate compound in demineralized water. Preferably, the stirring step is performed by carrying out a chemical process which occurs at a relatively high temperature (generally of between 20° C. and 80° C., preferably between 40° C. and 70° C.) in an aqueous solvent and preferably at ambient pressure (below for the sake of easier reference referred to also as “hydrothermal process”). The mechanical grinding of the dried solid product preferably comprises a ball-milling process.

The quantity of the ammonium phosphate compound, for example ammonium acid salt, in the aqueous solution is preferably less than or equal to 600 g per litre of solution and preferably between 25 and 400 grams per litre of aqueous solution. NH₄H₂PO₄ or (NH₄)₂HPO₄ as solutes of the solution are preferred because of the high solubility in water and the flame-resistance characteristics of both the phosphorus and the nitrogen.

The (NH₄)₂HPO₄ results in a solution with a higher, neutral or slightly alkaline pH, while NH₄H₂PO₄ results in an acid solution with a pH of about 4. The phosphorus-based compounds act both in the condensed phase and in the vapour phase when used as flame-resistant additives, for example dispersed in aqueous or polymer solutions.

The presence of nitrogen in NH₄ increases the fire-retarding characteristics of the phosphorus compounds and allows the release of gaseous nitrogen which dilutes the inflammable gases with a consequent reduction in the size of the flame.

In the preferred embodiment, a carbonaceous material, or a mixture thereof, is added in predefined amounts to an aqueous solution of an ammonium phosphate compound in order to form an aqueous dispersion. The weight ratio between ammonium phosphate compound and carbonaceous material present in the aqueous dispersion preferably ranges between 100:1 and 1:9, respectively, and even more preferably between 4:1 and 2:3. Moreover, the aqueous dispersion has a water content equal to at least 30% by weight of the total aqueous solution, more preferably of between 40% and 90%, and even more preferably of between 50% and 70%.

The fire-retarding powder according to the invention is therefore preferably obtained by dispersing the carbonaceous component or a mixture thereof in an aqueous solution of the ammonium phosphate compound—preferably chosen from monobasic ammonium phosphate and ammonium hydrogen phosphate, in order to obtain a colloidal dispersion of the carbonaceous component in the aqueous solution of ammonium phosphate compound.

The step of stirring the aforementioned aqueous dispersion is preferably performed by continuing to stir the dispersion for a minimum time period of 2 hours, preferably for a period of between 2 and 96 hours, and even more preferably between 24 and 48 hours. Moreover, during the stirring step, the aqueous dispersion is kept at a temperature of between 20° C. and 80° C., and more preferably between 40° C. and 70° C. Preferably, the volume of the aqueous dispersion remains constant during the mechanical stirring step using a reflux condenser or any other system common to the known technology, in order to keep the concentrations of reagents and the viscosity constant, and also prevent salt precipitation phenomena which could occur should the volume be excessively low due to evaporation of the water.

The inventors envisage that the hydrothermal process is able to introduce functional groups containing phosphorus into the structure of the carbonaceous material, if the carbonaceous material has reactive functional groups available for functionalization. Particularly preferred carbonaceous materials suitable for the functionalization of phosphorus using the hydrothermal process are graphene oxide, alkaline or sulfonated lignin since they comprise already hydroxyl and/or epoxy groups. Further preferred carbonaceous materials are carbon fillers, preferably carbon nanotubes, graphene, graphite, expandable graphite, carbon black or active carbon, which are provided with or have been pre-functionalized with hydroxyl, carboxyl and/or epoxy groups.

Drying of the aqueous dispersion of carbonaceous material is performed by increasing the temperature of the aqueous dispersion to a temperature of not higher than 95° C., preferably between 80° C. and 90° C., allowing the dispersion water to evaporate.

Once dried, the solid product obtained must undergo a mechanical cleaving step, preferably mechanical grinding, in order to obtain the fire-retarding powder according to the invention. Grinding is preferably performed using a ball mill employing a ball-milling process. Grinding is performed at a mill speed of between 200 rpm and 12,000 rpm, more preferably between 600 rpm and 10,000 rpm. The duration of the ball-milling process is that sufficient to ensure suitable homogenization and grinding of the dried product, typically not less than 30 minutes' duration. Suitable homogenization and grinding are considered to be achieved when a powder composition with a degree of homogeneity and/or particle size as defined above is obtained. The mechanical cleaving step, for example in the form of the mechanical grinding operation described above, has the aim of reducing the particle size of the dried solid product, thus obtaining a powder and homogenizing the composition thereof and achieving at least partial functionalization of the carbonaceous material with phosphate groups. Without being limited to any particular theory, the inventors envisage that the mechanical cleaving process, and in particular ball milling, is able to introduce phosphorus functional groups into the structure of the carbonaceous material as a result of mechanical cleaving of the bonds C—C and C═C, creating —C. radicals. The —C. radicals react rapidly with the adjacent phosphate groups forming C—P and/or C—O—P bonds.

In particular, at least some of the phosphate functional groups are insolubly bonded to the carbonaceous component. Namely, they cannot split therefrom by means of simple immersion in solvent. The solvent is in particular water, an aqueous solvent or other polar solvent (water being the solvent which is most commonly used in the sector and in which the phosphate salts are more soluble).

According to a further preferred mode of implementation, the fire-retarding powder composition is obtained directly by means of mechanical cleaving, for example by performing simultaneous grinding of the ammonium phosphate compound and the carbonaceous component. It is understood that in this case the mechanically ground solid product comprises the ammonium phosphate compound and the carbonaceous component in the solid state.

According to an alternative mode of implementation, it is possible to obtain the solid product which is to undergo mechanical cleaving by performing one or more cycles involving centrifuging of an aqueous dispersion of the carbonaceous material in an aqueous solution of the ammonium phosphate compound described above, before the drying step. The centrifuged and dried solid product thus obtained generally consists of only the carbonaceous material, optionally partly functionalized by the hydrothermal process, and is then subjected to cleaving, for example grinding it simultaneously with an ammonium phosphate compound in the solid state. In accordance with this aspect of the invention, the fire-retarding powder may be obtained directly by means of mechanical grinding of the carbonaceous material with the ammonium phosphate compound using the ball milling process. The carbonaceous material and the ammonium phosphate compound are inserted in solid form into the ball mill in amounts defined by the same ratio ranges indicated for the preparation of the aqueous dispersion. Grinding is performed at a mill speed of between 200 rpm and 12,000 rpm, more preferably between 600 rpm and 10,000 rpm, where a suitable cleaving power may be obtained as a result of the impact of the balls with the said material. The duration of the ball-milling process is that sufficient to ensure suitable homogenization and grinding of the dried product, typically not less than 60 minutes' duration.

The minimum and maximum preferred values of the different materials forming the carbonaceous component which are indicated above define ranges so that a fire-retarding power with excellent flame-resistance properties is obtained, being easily dispersible in a polymer such as a water-based polymer dispersion.

The fire-retarding powder according to the invention has a fire-retarding capacity already for relatively low concentrations of the carbonaceous component, for example greater than or equal to 0.5% by weight of the powder; it is considered that this is due to the synergic interaction between the ammonium phosphate compound and the carbonaceous material when the powder is used as a flame-resistant agent.

Above the preferred maximum values indicated there is no percentage increase in the fire-retarding properties such as to justify the greater cost of the mixture. The quantity of reagents may be chosen within the composition ranges indicates depending on the desired effect and the fabric to be treated.

The quantity of carbon fillers, in particular graphene oxide and/or carbon nanotubes, present in the solution according to the invention are able to optimize the capacity of these components to graphitize and form a “vitreous” layer or “char layer” during combustion; said layer is extremely compact, forming an optimum physical barrier against the propagation of heat and the transportation of material towards the combustion zone, limiting in fact propagation and further flame development.

In addition, graphene oxide has two major advantages: the carboxyl, hydroxyl and epoxy groups present make the graphene relatively dispersible in water, preventing therefore the use of organic solvents, which are generally inflammable, and, moreover, being reactive chemical groups, they enable the functionalization of the graphene with other chemical species such as phosphate and silane groups, which are particularly useful in flame-resistant applications.

According to a further aspect of the invention it is envisaged that a powder composition of the present invention, for example obtained using one of the modes of implementation described, may be used as a fire-retarding additive by mixing it with a water-based polymeric emulsion, in order to obtain a fire-retarding mixture in the form of a polymeric dispersion which is particularly suitable for the treatment of a surface such as, for example, the surface of a fabric.

The polymeric dispersion with additives comprises:
a water-based polymeric emulsion which acts as a polymeric binder;
an ammonium phosphate compound solubilized in the emulsion;
the carbonaceous component at least partly functionalized with phosphate groups in the dispersed phase;
optional additives.

The water-based polymeric emulsion is preferably chosen from polyurethane, polyacrylic, polystyrene, EVA or a polymeric emulsion containing a styrene-based copolymer. According to a further preferred embodiment, the emulsion is a latex, for example a butadiene-based latex, preferably a styrene-butadiene latex.

EVA or an acrylic-styrene copolymer emulsion are particularly preferred emulsions.

Generally the solid polymeric part may be for example comprised between 40% and 60% by weight of the polymeric emulsion.

The optional additives may be one or more of the following types of additive: fluidifying agents, thickening agents, soaking agents, softening agents, foaming agents, further flame-resistant additives, water repellents, colouring agents.

The polymeric dispersion with fire-retarding powder additive is obtained by adding the fire-retarding powder according to the invention and any additives to the polymeric emulsion, followed by a mechanical mixing step sufficient for ensuring the complete solubilization of the ammonium phosphate compound and dispersion of the at least partly functionalized carbonaceous component in the emulsion, according to the methods within the competence of the person skilled in the art.

Preferably, the powder according to the invention is added to the polymeric emulsion in amounts such that the ammonium phosphate compound and the carbonaceous component are present in the final polymeric mixture in amounts of not less than 0.5% by weight of the final polymeric mixture.

It is within the competence of the person skilled in the art to select a fire-retarding powder with a given ammonium phosphate compound depending on the pH of the polymer binder in order to prevent crosslinking of the polymer induced by the pH. For example, the ammonium phosphate compound in the powder according to the invention may be hydrogen phosphate for alkaline pH values of the polymer binder or dihydrogen phosphate for middle-range acid pH values.

The final mixture, which is generally in the form of a colloidal dispersion, may have a viscosity of more than 2500 cPa, preferably of between 4000 and 10,000, which is spreadable in an optimum manner.

The mixture (dispersion) obtained may also be foamed in order to facilitate the application to a fabric. A process of foaming the mixture according to the invention involves stirring the mixture inside a storage tank and supplying it at room temperature to a foaming machine where the density values (g/l) and dispensing rate (preferably an average value of about 55 I/h) have been pre-set for the final product.

The mixture subjected to foaming may be easily applied to the fabric, in particular by means of conventional back-coating processes.

The present invention relates furthermore to a method for the fireproofing treatment of a fabric and a fireproof fabric comprising a fabric base layer to which a mixture according to any one of the embodiments described above has been applied.

Preferably, the mixture applied to the fabric is foamed beforehand. According to preferred modes of implementation of the treatment method, a mixture according to the invention in the form of a polymer dispersion with fire-retarding powder described above may be applied, preferably sprayed or spread, onto the back of a fabric, for example by means of an applicator blade. Preferably, the layer of applied mixture has a thickness of at least 0.02 mm, preferably comprised between 0.1 and 2 mm, more preferably between about 0.3 and 1 mm. Preferably, the fabric is kept tensioned during application of the mixture, so as to obtain a uniform coating.

At the end of the application process, the treated fabric is subjected to a heat treatment at a temperature of between 100° C. and 180° C., preferably between 120° C. and 160° C. for a time period of between 1 and 20 minutes, preferably between 2 and 10 minutes. The heat treatment causes crosslinking of the polymeric phase of the mixture, with formation of a layer of fire-retarding film comprising a polymer matrix with the carbonaceous component at least partly functionalized with phosphates and the ammonium phosphate compound in the dispersed phase inside it. During this phase the thickness of the mixture layer applied may be reduced.

The weight of the fire-retarding layer obtained is preferably less than 70% of the weight of the fabric per square metre, generally between 10% and 70%, more preferably between 20% and 40%, of the weight of the fabric per square metre.

### EXAMPLES AND TEST DATA

### Example 1—Preparation of the Fire-Retarding Powder from an Aqueous Dispersion

The fire-retarding powder is prepared by means of a hydrothermal process followed by ball milling. The quantities and composition percentages shown in Table 1 relate to the preparation of 2 kg of aqueous dispersion containing carbonaceous material.

TABLE 1
Composition of the aqueous dispersion

| Material | Quantity [g] | Composition (%) |
|---|---|---|
| Graphene oxide | 30 | 1.5 |
| NH₄H₂PO₄ | 270 | 13.5 |
| Demin. water | 1700 | 85 |

An example of a powder composition according to the invention is prepared as follows: 1700 g of demineralized water are poured inside a beaker and stirred at 300 rpm using a hot plate “AREX 630W”, WELP SCIENTIFICA. 30 g of graphene oxide (NANOXPLORE, C 75 w %, C 20 w %) are added to this volume of water, while keeping the aqueous dispersion stirred for 30 minutes, followed by a further 30 minutes of sonication in order to favour the dispersion of the graphene oxide. Then 270 g of NH₄H₂PO₄ are added while constantly stirring. At the end of this step the aqueous dispersion containing the carbonaceous material is heated to 70°, kept at this temperature for a period of 24 hours, while continuing to stir and keeping the volume constant by means of a reflux condenser. Drying is performed by raising the temperature of the bath to 90° C. for the time needed to achieve complete evaporation of the water. The dried product is further dried for 6 hours at 70° C. in a vacuum oven. The dried product was ground using a ball mill “MILL MM 200”, RETSCH. About 30 g of dried product were inserted in the jar together with chrome-plated balls with a diameter of 1.5 cm and 0.5 cm. The speed of rotation was fixed at 400 rpm for 30 minutes. At the end of the procedure a homogeneous powder with optimum fire-retarding properties is obtained. FIGS. 1 and 2 show graphs for the thermogravimetric analysis (TGA) carried out on the dry product before and after the grinding step, respectively. The test was carried out in air with a thermal ramp of 10° C./min. It is clear from the two graphs that the fire-retarding powder obtained following grinding has improved fire-retarding properties, as shown by the final residue at 900° C.: 23.3% for the non-ground dried product and 59.2% for the fire-retarding powder after ball-mill grinding.

FIGS. 3 and 4 show the SEM images of the dried product before ball-mill grinding and the fire-retarding powder after ball-mill grinding. It is clear that in FIG. 4 the particle size of the powder is smaller, as a result of the mechanical grinding operation.

Table 2 shows the average composition in percentage weight of the samples shown in FIG. 3 and FIG. 4 (dried dispersion and powder composition of Example 1, respectively). The composition was calculated by means of EDS analysis. The fire-retarding powder according to the invention, obtained by means of mechanical cleaving, has a high concentration by weight of phosphorus and nitrogen, i.e. about 23% and 6% respectively, which explains the excellent flame-resistance properties of the powder. Moreover, the presence of about 26% carbon favours the formation of the carbonaceous vitreous layer during combustion.

TABLE 2
Average composition of the dried product before
ball-mill grinding and after ball-mill grinding

| Sample | C (w %) | N (w %) | O (w %) | P (w %) | Total (w %) |
|---|---|---|---|---|---|
| Dried | 17.65 | 10.96 | 50.44 | 20.95 | 100.00 |
| product | | | | | |
| Fire- | 26.33 | 6.01 | 43.98 | 23.68 | 100.00 |
| retarding | | | | | |
| powder | | | | | |

The fire-retarding powder composition has a relatively high solubility in water, something which is advantageous for its dispersion in a polymer emulsion as flame-resistant agent, in order to facilitate application for example to a fabric.

The process described for the preparation of the fire-retarding powder is however able to introduce into the structure itself of the carbonaceous material, in this case graphene oxide, phosphorus-containing functional groups which are insoluble and maintain a certain degree of flame-resistance also following immersion in water, ensuring the effectiveness of the composition as fireproofing agent even when it is dispersed in the polymer phase of an aqueous polymeric emulsion for application to a material to be treated.

The insolubility of the bonds between the phosphate groups and the carbonaceous component may for example be determined by dispersing the functionalized fire-retarding powder in water and extracting an insoluble residue (for example with vacuum filtration or centrifuging) which is subjected to at least two water rinsing cycles (preferably at least 1 litre of water per g of powder composition is used) and subsequent vacuum filtration or centrifuging. The resultant powder may then be dried again and analysed in order to check for the presence of phosphorus and/or phosphorus groups bonded to the carbonaceous component. In particular the presence of C—P and/or optionally C—O—P bonds may also be checked for, where necessary. Suitable analysis methods are for example ICP, EDX or EDS, which are commonly used to analyse the basic composition and therefore are useful for detecting the presence of phosphorus, or for example XPS or FTIR, able to detect chemical bonds such as in particular C—P o C—O—P bonds.

in order to demonstrate the at least partial functionalization of the carbonaceous component, 2 g of dried powder composition obtained following drying and grinding according to Example 1 were re-dispersed in 500 mL of water. The insoluble residue was filtered through a glass fibre membrane with an average porosity of 3μ, using a suction filtration flask. The filtered product was rinsed with a further 500 mL of water to ensure the elimination of any soluble part. FIG. 5 shows the SEM image of the product filtered and dried again, while Table 3 shows the average composition by weight thereof, calculated by means of EDS analysis. The dry product rinsed, filtered and dried again does not contain nitrogen, but maintains phosphorus in an average amount of 0.52% by weight, indicating the at least partial chemical functionalization of the graphene oxide with phosphorus.

TABLE 3
Average weight composition of the dry product obtained
by rinsing, filtering and drying again the powder composition
according to Example 1. The average value is calculated
based on the average of three points.

| | C | O | P | Total |
|---|---|---|---|---|
| 1 | 83.48 | 15.91 | 0.61 | 100.00 |
| 2 | 88.42 | 11.43 | 0.15 | 100.00 |
| 3 | 83.95 | 15.25 | 0.80 | 100.00 |
| Average | 85.28 | 14.20 | 0.52 | 100.00 |

### Example 2—Preparation of the Polymeric Dispersion with Flame-Retarding Additive Powder

Below the procedure for the preparation of 1 kg of polymer dispersion, in particular suitable for the back-coating of fabrics, with the added fire-retarding powder composition prepared according to Example 1, defined as GOP, is described. Appretan N96101 (ARCHROMA), a dispersion of a styrene-acrylic copolymer, was used as polymer emulsion. Table 4 shows the percentage weight composition of the polymer dispersion with additives.

TABLE 4
Weight composition of the polymer dispersion with additives

| Material | Quantity [g] | Composition (%) |
|---|---|---|
| Appretan N96101 | 644.3 | 64.4 |
| GOP | 193 | 19.3 |
| Water | 163 | 16.3 |

For the preparation, 644.3 g of Appretan N96101 were stirred using a mechanical mixer at 300 rpm. Then 100 g of GOP and 80 g of water are added, while constantly stirring. After 30 minutes the remaining 93 g of GOP and 83 g of water are added, while continuing stirring for a further 30 minutes until a homogeneous composition is obtained. The polymer dispersion with additives thus obtained has a dark grey colour and a viscosity of about 6900 mPas, suitable for conventional spreading on fabrics by means of back-coating.

### Example 3—Treatment of Fabrics with Polymer Dispersion Containing Additives According to Example 2

Three fabrics with a different composition were treated by means of back-coating with the polymer dispersion containing additives according to Example 2. The composition of the treated fabrics is shown in Table 5.

TABLE 5
Composition of the treated fabrics

| Fabric | Composition | Weight per area (g/m²) |
|---|---|---|
| 1 | PES/WO | 305 |
| 2 | CO 60/PES 40 | 290 |
| 3 | PAC | 275 |

The polymer dispersion with additives according to Example 2 was applied by means of back-coating using an applicator blade, adjusting the thickness of the coating to a value of between 20 μm and 100 μm. The treated fabrics were subjected to a heat treatment in order to promote crosslinking of the polymer phase and tested for their flame behaviour according to DIN standard 4102 B2. Table 6 shows the results of the test for the various fabrics and thicknesses of the coating. The results show that the polymer dispersion with the added GOP powder prepared according to Example 2 is effective as a flame-resistance treatment applied to fabrics, in particular for fabrics which contain a natural fibre part.

TABLE 6
Results of the flame tests according to DIN standard 4102 B2

| | | 20 | 50 | 100 |
|---|---|---|---|---|
| Fabric | Untreated | μm | μm | μm |
| 1 | | | | |
| Time taken to reach 15 cm mark (s) | 15 | — | — | — |
| Total duration of combustion (s) | 42 | 12 | 14 | 11 |
| Char length (cm) | >15 | 4.8 | 4.3 | 3.9 |
| Number of drops (n) | 0 | 0 | 0 | 0 |
| Lighting of filter paper within 20 s | No | No | No | No |
| (Yes/No) | | | | |
| Test Passed (Yes/No) | No | Yes | Yes | Yes |
| 2 | | | | |
| Time taken to reach 15 cm mark (s) | 19 | — | — | — |
| Total duration of combustion (s) | 46 | 9 | 8 | 8 |
| Char length (cm) | >15 | 5.1 | 5.2 | 5.1 |
| Number of drops (n) | 0 | 0 | 0 | 0 |
| Lighting of filter paper within 20 s | No | No | No | No |
| (Yes/No) | | | | |
| Test Passed (Yes/No) | No | Yes | Yes | Yes |
| 3 | | | | |
| Time taken to reach15 cm mark (s) | 8 | 17 | 22 | 23 |
| Total duration of combustion (s) | 24 | 86 | 93 | 90 |
| Char length (cm) | >15 | >15 | >15 | >15 |
| Number of drops (n) | 1 | 0 | 1 | 1 |
| Lighting of filter paper within 20 s | Yes | No | No | No |
| (Yes/No) | | | | |
| Test Passed (Yes/No) | No | No | No | Yes |

### Example 4—Preparation of the Fire-Retarding Powder from an Aqueous Dispersion

The fire-retarding powder is prepared by means of a hydrothermal process followed by ball milling. The quantities and composition percentages shown in Table 7 relate to the preparation of 2 kg of aqueous dispersion containing carbonaceous material.

TABLE 7
Composition of the aqueous dispersion

| Material | Quantity [g] | Composition (%) |
|---|---|---|
| Graphene oxide | 60 | 3 |
| CNT | 60 | 3 |
| NH₄H₂PO4 | 180 | 9 |
| Demin. water | 1700 | 85 |

An example of a powder composition according to the invention is prepared as follows: 1700 g of demineralized water are poured inside a beaker and stirred at 300 rpm using a hot plate “AREX 630W”, WELP SCIENTIFICA. 60 g of graphene oxide (NANOXPLORE, C 75 w %, C 20 w %) and 60 g of carbon nanotubes (Sigma Aldrich) are added to this volume of water, while keeping the aqueous dispersion stirred for 30 minutes, followed by a further 30 minutes of sonication in order to favour the dispersion of the graphene oxide. Then 180 g of NH₄H₂PO₄ are added while constantly stirring. At the end of this step the aqueous dispersion containing the carbonaceous material is heated to 70°, kept at this temperature for a period of 24 hours, while continuing to stir and keeping the volume constant by means of a reflux condenser. Drying is performed by raising the temperature of the bath to 90° C. for the time needed to achieve complete evaporation of the water. The dried product is further dried for 6 hours at 70° C. in a vacuum oven. The dried product was ground using a ball mill “MIXER MILL MM 200”, RETSCH. About 30 g of dried product were inserted in the jar together with chrome-plated balls with a diameter of 1.5 cm and 0.5 cm. The speed of rotation was fixed at 600 rpm for 60 minutes. At the end of the procedure a homogeneous powder with optimum fire-retarding properties is obtained.

### Example 5—Preparation of the Fire-Retarding Powder from an Aqueous Dispersion

The fire-retarding powder is prepared by means of a hydrothermal process followed by ball milling. The quantities and composition percentages shown in Table 8 relate to the preparation of 2 kg of aqueous dispersion containing carbonaceous material.

TABLE 8
Composition of the aqueous dispersion

| Material | Quantity [g] | Composition (%) |
|---|---|---|
| Graphene oxide | 30 | 1.5 |
| Expandable graphite | 20 | 1 |
| NH₄H₂PO4 | 250 | 12.5 |
| Demin. water | 1700 | 85 |

An example of a powder composition according to the invention is prepared as follows: 1700 g of demineralized water are poured inside a beaker and stirred at 300 rpm using a hot plate “AREX 630W”, WELP SCIENTIFICA. 30 g of graphene oxide (NANOXPLORE, C 75 w %, C 20 w %) and 20 g of expandable graphite (Sigma Aldrich) are added to this volume of water, while keeping the aqueous dispersion stirred for 30 minutes, followed by a further 30 minutes of sonication in order to favour the dispersion of the graphene oxide. Then 250 g of NH₄H₂PO₄ are added while constantly stirring. At the end of this step the aqueous dispersion containing the carbonaceous material is heated to 70°, kept at this temperature for a period of 24 hours, while continuing to stir and keeping the volume constant by means of a reflux condenser. Drying is performed by raising the temperature of the bath to 90° C. for the time needed to achieve complete evaporation of the water. The dried product is further dried for 6 hours at 70° C. in a vacuum oven. The dried product was ground using a ball mill “MIXER MILL MM 200”, RETSCH. About 30 g of dried product were inserted in the jar together with chrome-plated balls with a diameter of 1.5 cm and 0.5 cm. The speed of rotation was fixed at 1200 rpm for 20 minutes. At the end of the procedure a homogeneous powder with optimum fire-retarding properties is obtained.

### Example 6—Preparation of the Fire-Retarding Powder from an Aqueous Dispersion

In a further preferred embodiment, the aqueous dispersion prepared according to Example 5 is kept constantly stirred at 300 rpm at a constant temperature of 80° C. for 8 hours, at the end of which centrifuging of the aqueous dispersion is performed. The precipitate is recovered and subjected to centrifuging cycles, with re-dispersion of the centrifuged product in water at least three times until only the carbonaceous material is obtained. This precipitate is then dried at a temperature of 80° C. for 6 hours. The dried precipitate thus obtained is then subjected to a ball milling process together with ammonium dihydrogen phosphate, at 800 rpm for two hours, in a nitrogen atmosphere, resulting in a homogeneous powder.

1. A fire-retarding composition comprising:
a carbonaceous component at least partly functionalized with phosphate groups;
an ammonium phosphate compound;
wherein the composition is in the form of a homogeneous powder and wherein the carbonaceous component is chosen from: carbon nanotubes, graphene, graphene oxide, graphite, oxidized graphite, expandable graphite, carbon black, active carbon, alkaline or sulfonated lignin, or a combination thereof.

2. A composition according to claim 1, wherein the carbonaceous component is in an overall amount equal to at least 0.5% by weight, more preferably between 5% and 90%, even more preferably between 20% and 60% by weight of the powder composition.

3. A composition according to claim 1, wherein the carbonaceous component comprises carbon nanotubes in an amount equal to at least 0.5% by weight, more preferably between 10% and 40% by weight of the powder composition.

4. A composition according to claim 1, wherein the carbonaceous component comprises oxidized graphite preferably in an amount equal to at least 0.5% by weight, more preferably between 20% and 50% by weight of the powder composition.

5. A composition according to claim 1, wherein the carbonaceous component comprises graphene oxide in an amount equal to at least 0.5% by weight, preferably between 5% and 80%, even more preferably between 10% and 40% by weight of the powder composition.

6. A powder composition according to claim 1, wherein the ammonium phosphate compound is an ammonium salt of phosphoric acid, preferably chosen from monobasic ammonium phosphate NH₄H₂PO₄, ammonium hydrogen phosphate (NH₄)₂HPO₄, ammonium phosphate (NH₄)₃PO₄ and ammonium polyphosphate [H₄PO₃]ₙ.

7. A powder composition according to claim 1, wherein the ammonium phosphate compound is in an amount of between 5% and 99.5%, more preferably between 30% and 60% by weight of the powder composition.

8. A composition according to claim 1, characterized in that it has a particle size of between 100 nm and 1000 μm, preferably between 200 nm and 500 μm, even more preferably between 200 nm and 50 μm.

9. A powder composition according to claim 1, characterized in that it has a concentration by weight of phosphorus greater than or equal to 10%, preferably greater than or equal to 22%, and/or a concentration by weight of nitrogen greater than or equal to 2%, preferably greater than or equal to 5%, and/or a concentration by weight of carbon greater than or equal to 0.5%, preferably greater than or equal to 15%.

10. A powder composition according to claim 1, characterized in that it has a phosphorus/carbon ratio of between 0.01:1 and 45:1.

11. A powder composition according to claim 1, characterized in that it has a final residue at 900° C., measured with TGA analysis, greater than or equal to 40%, preferably between 50% and 70%, more preferably greater than or equal to 59%.

12. A composition according to claim 1, characterized in that it contains a percentage of product soluble in water equal to at least 4% by weight.

13. A process for the production of a composition according to claim 1, comprising the following steps:
obtaining a solid product comprising an ammonium phosphate compound and a carbonaceous material, chosen from carbon nanotubes, graphene, graphene oxide, graphite, oxidized graphite, expandable graphite, carbon black, active carbon, alkaline or sulfonated lignin, or a combination thereof;
mechanical cleaving of the solid product with solid/solid interaction of the components of the solid product to obtain a composition in the form of a homogeneous powder in which the carbonaceous component is at least partly functionalized with phosphate groups.

14. The process according to claim 13, wherein the solid product is obtained by means of the following steps:
preparation of a colloidal aqueous dispersion of the carbonaceous component in an aqueous solution of an ammonium phosphate compound;
stirring the dispersion, preferably for at least 2 hours;
drying the dispersion so as to obtain a dried solid product.

15. The process according to claim 14, wherein the colloidal dispersion is obtained from an aqueous solution, dispersing the carbonaceous component and the ammonium phosphate compound in demineralized water; and/or
the stirring step is performed at a temperature of between 20° C. and 80° C., preferably between 40° C. and 70° C., in an aqueous solvent and preferably at ambient pressure.

16. The process according to claim 14, wherein the step of stirring the dispersion is performed under constant volume conditions, preferably by means of a reflux condenser.

17. The process according to claim 13, wherein the solid product is obtained by mixing an ammonium phosphate compound and a carbonaceous component in the solid state.

18. The process according to claim 13, wherein mechanical cleaving comprises mechanical grinding of the solid product.

19. The process according to claim 18, wherein the mechanical grinding comprises a ball-milling process in a ball mill, wherein grinding is performed preferably at a mill speed of between 200 rpm and 12,000 rpm, more preferably between 600 rpm and 10,000 rpm.

20. A use for the powder composition of claim 1 as a flame-resistant additive in a fire-retarding mixture.

21. A fire-retarding mixture in the form of a polymeric dispersion comprising:
a water-based polymeric emulsion, preferably chosen from polyurethane, polyacrylic, polystyrene, EVA, a polymeric emulsion containing styrene-based copolymer, more preferably EVA or an acrylic-styrene copolymer emulsion; or a latex, preferably a butadiene-based latex, for example a styrene-butadiene latex;
a powder composition according to claim 1.

22. A mixture according to claim 21, wherein the ammonium phosphate compound is solubilized in the aqueous emulsion and the carbonaceous component at least partly functionalized with phosphate groups is in a dispersed phase.

23. A mixture wherein the ammonium phosphate compound is solubilized in the aqueous emulsion and the carbonaceous component at least partly functionalized with phosphate groups is in a dispersed phase is obtained by adding a fire-retarding powder composition according to claim 1 to the water-based polymeric emulsion and mixing the polymeric emulsion.

24. A method for treating a fabric comprising a step of applying a fire-retarding mixture comprising a composition according to claim 1 onto a surface of the fabric and a step of heat treatment of the fabric.

25. The method according to claim 24, comprising a step of preparing the mixture performed by:
dispersing the composition in a water-based polymeric emulsion, preferably chosen from polyurethane, polyacrylic, polystyrene, EVA, a polymer emulsion containing styrene-based copolymer, more preferably EVA or an acrylic-styrene copolymer emulsion; or a latex, preferably a butadiene-based latex, for example a styrene-butadiene latex;
mixing the polymeric emulsion until complete solubilization of the ammonium phosphate compound and dispersion of the component therein are obtained.

26. The method according to claim 25, wherein the mixture is foamed before application to the fabric; and/or wherein application to the fabric is performed by means of spreading.

27. A fabric comprising a fire-retarding layer comprising a polymeric matrix with a carbonaceous component at least partly functionalized with phosphate groups and an ammonium phosphate compound in a dispersed solid phase, wherein optionally the polymeric matrix comprises or is formed by polyurethane, polyacrylic, polystyrene, EVA, or a polymeric emulsion containing styrene-based copolymer, more preferably EVA or an acrylic-styrene copolymer emulsion; or a latex, preferably a butadiene-based latex, for example a styrene-butadiene latex.

28. A fabric, comprising a fire-retarding layer comprising a polymeric matrix with a carbonaceous component at least partly functionalized with phosphate groups and an ammonium phosphate compound in a dispersed solid phase, wherein optionally the polymeric matrix comprises or is formed by polyurethane, polyacrylic, polystyrene, EVA, or a polymeric emulsion containing styrene-based copolymer, more preferably EVA or an acrylic-styrene copolymer emulsion; or a latex, preferably a butadiene-based latex, for example a styrene-butadiene latex wherein the fire-retarding layer is obtained by means of heat treatment at a temperature greater than 100° C. of a mixture according to claim 21 being applied to a surface of the fabric.
